(19) United States
(12) Patent Application Publication
(10) Pub. No.: US 2011/0013034 A1
(43) Pub. Date: Jan. 20, 2011

(54) METHOD FOR OPERATING DIGITAL CAMERA AND DIGITAL CAMERA USING THE SAME

(75) Inventors: Chih-Wei Chiang, Hsinchu City (TW); Sheng-Feng Ho, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/503,113

(22) Filed: Jul. 15, 2009

(51) Int. Cl. H04N 5/228

(52) U.S. Cl. 348/222.1; 348/E05.031

(57) ABSTRACT

The invention discloses an electronic device, including an image sensor and a central processing unit (CPU). The image sensor detects a plurality of image frames generated during the manipulation of the electronic device caused by external force. The CPU determines an electronic motion pattern of the plurality of image frames, determines whether the electronic motion pattern matches a predetermined motion pattern defining a functional operation of the electronic device, and performs the functional operation when the electronic motion pattern matches the predetermined motion pattern.

### BACKGROUND OF THE INVENTION

1. Field of the Invention

The invention relates generally to a method for operating a digital camera, and more particularly, to a method for operating a digital camera without pressing a button of the digital camera.

2. Description of the Related Art

Driven by continued technological advancements, demand for miniaturized electronic products have grown. However, miniaturized electronic products are not always convenient to operate. Take a miniaturized digital camera (may also be any miniaturized electronic products with function of picture taking, such as a cell phone) as an example, if a user holds the miniaturized digital camera with single hand (single-hand operation) when taking a picture, it would be very difficult to hold it steadily due to the small shutter button not being friendly for operation. This results in capturing a blurred image, because in the instant the shutter button is pressed there is a force inevitably applied upon the light/miniaturized digital camera, causing the camera to shake. To steadily hold the light/miniaturized digital camera, the user may need to use two hands (double-hand operation). However, it is also not a friendly way for operating the miniaturized digital camera since the miniaturized digital camera is too small to be properly held.

In this case, a single-hand operation of digital camera is preferred as a double-hand operation of digital camera may not be convenient for quick operation. However, the single-hand operation of digital camera still requires operation with smaller shutter button, which is difficult to hold the camera steady while pressing the shutter button. To solve the problem, a delay shutter is employed to keep a time gap between the user presses the shutter bottom and the picture is actually taken. The delay shutter does solve the problem of blurred images because the picture is not taken immediately in the instant the shutter button is pressed. With the delay shutter, however, it is not easy to handle the timing of picture taking, as the time gap may be too short or too long.

In light of the problem, there has been a trend for button-free operation of miniaturized digital camera. Conventionally, a voice control of digital camera has been developed to avoid using shutter button for capturing pictures. However, the voice control involves difficulties such as the complications due to different languages, tone, volume, as well as a privacy consideration (people may not want to disturb the subject when taking picture).

Furthermore, an US patent application (US 20060242434 A1) discloses using some inertial components such as a gyro to determine a user's intention, which is also a button-free operation. However, the use of inertial components requires additional components to be integrated in the digital camera, raising a cost consideration and a possibility of reduced yield rate (resulting from the calibration of these inertial components), even an extra power consumption.

### BRIEF SUMMARY OF THE INVENTION

In light of the problem stated previously, operating a digital camera without pressing buttons is required.

The invention discloses an electronic device, comprising an image sensor and a central processing unit (CPU). The image sensor detects a plurality of image frames generated during the manipulation of the electronic device caused by external force. The CPU determines an electronic motion pattern of the plurality of image frames, determines whether the electronic motion pattern matches a predetermined motion pattern defining a functional operation of the electronic device, and performs the functional operation when the electronic motion pattern matches the predetermined motion pattern.

The invention discloses a method for operating an electronic device, comprising the steps of detecting a plurality of image frames generated during the manipulation of the electronic device caused by external force, determining an electronic motion pattern of the plurality of image frames, determining whether the electronic motion pattern matches a predetermined motion pattern defining a functional operation of the electronic device, and performing the functional operation when the electronic motion pattern matches the predetermined motion pattern.

### BRIEF DESCRIPTION OF THE DRAWINGS

The invention can be more fully understood by reading the subsequent detailed description and examples with references made to the accompanying drawings, wherein:

FIG. 1 shows a block diagram of an electronic device according to an embodiment of the invention;

FIGS. 2a-2d show four exemplary predetermined manipulation manners of an electronic device according to an embodiment of the invention;

FIG. 3 shows a diagram including two detailed procedures performed by an image processor as well as two detailed procedures performed by a CPU according to an embodiment of the invention;

FIG. 4 shows a diagram illustrating electronic local motion patterns of an image frame according to an embodiment of the invention;

FIG. 5 shows an operation flowchart of a digital camera according to an embodiment of the invention;

FIG. 6 shows a detailed flowchart for determining an electronic motion pattern of image frames generated by user manipulation according to an embodiment of the invention;

FIG. 7 shows a flowchart illustrating a practical application of the digital camera 100 according to an embodiment of the invention;

FIG. 8 shows a block diagram of an electronic device according to another embodiment of the invention;

FIG. 9 shows a diagram of a user having a predetermined facial expression for operating a digital camera according to an embodiment of the invention;

FIG. 10 shows an operation flowchart of a digital camera according to another embodiment of the invention; and

FIG. 11 shows a flowchart illustrating a practical application of the digital camera 200 according to an embodiment of the invention.

### DETAILED DESCRIPTION OF THE INVENTION

The following description is of the best contemplated mode of carrying out the invention. This description is made for the purpose of illustrating the general principles of the invention and should not be taken in a limiting sense. The scope of the invention is best determined by reference to the appended claims.

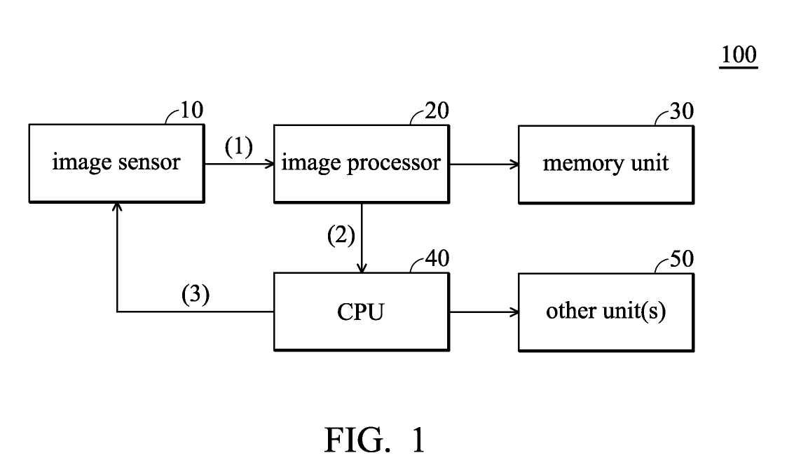

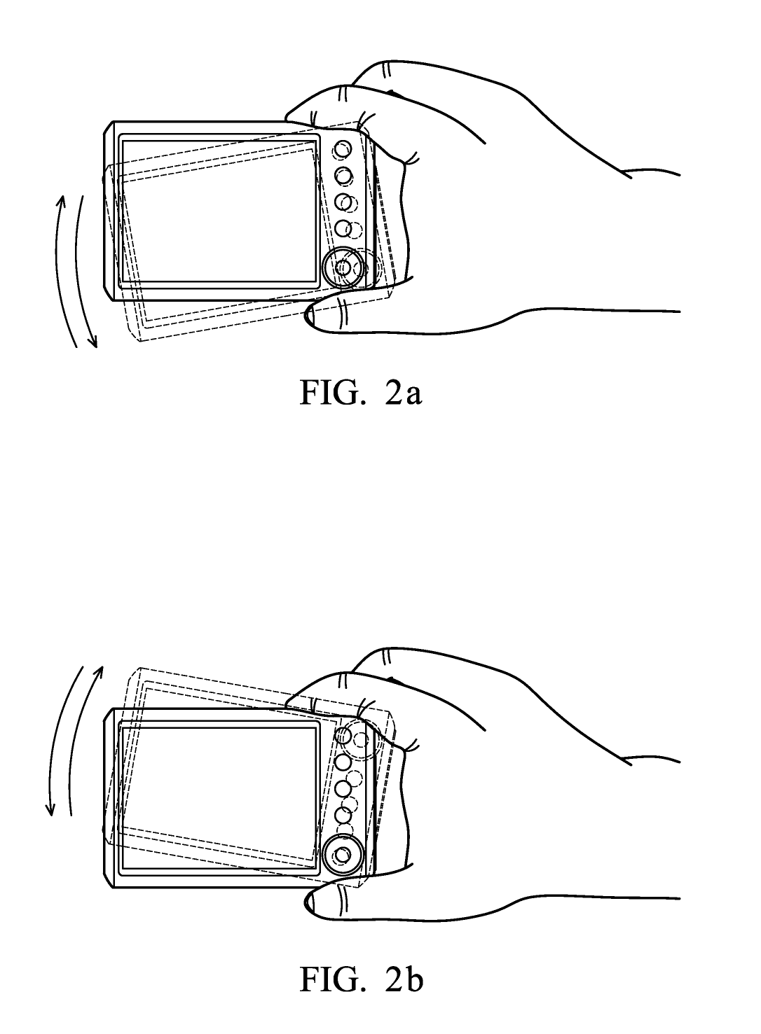

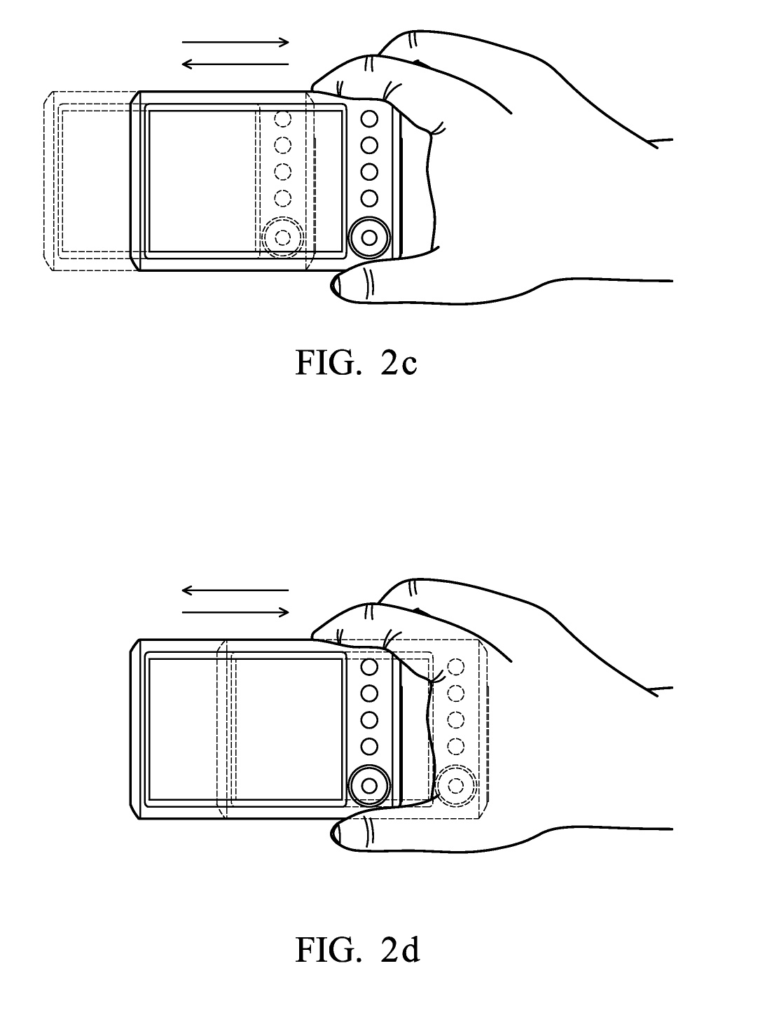

FIG. 1 shows a block diagram of an electronic device according to an embodiment of the invention. The electronic device 100 comprises an image sensor 10, an image processor 20, a memory unit 30, a Central Processing Unit (CPU) 40 and other unit(s) 50 to be controlled by the CPU 40. The electronic device 100 may be a device capable of taking pictures, such as a digital camera (which is hereinafter used as an example for illustration of the invention), a Personal Digital Assistant (PDA), a cell phone and the like. The image sensor 10 is the lens of the digital camera 100. Instead of the traditional cameras requiring users to press a button to take pictures, the embodiment of the invention simply requires users to manipulate (without pressing any button) the digital camera 100 in a predetermined manner to trigger a picture taking function. The predetermined manipulation manner, for example, may be rotating the electronic device 100 back and forth in an angle leftwards or rightwards, as shown in FIGS. 2a and 2b, or shifting the electronic device 100 back and forth leftwards or rightwards within a distance, as shown in FIGS. 2c and 2d, but is not limited thereto. The predetermined manipulation manner of the digital camera 100 serves as an instruction for a certain functional operation of the digital camera 100, and different predetermined manipulation manners represent different instructions for different functional operations of the digital camera 100. For example, a predetermined manipulation manner of rotating the digital camera 100 in an angle back and forth (as shown in FIGS. 2a and 2b) may represent an instruction for taking a picture in a regular mode (one picture shooting at once), and a predetermined manipulation manner of shifting the digital camera 100 within a distance back and forth (as shown in FIGS. 2c and 2d) may represent another instruction for taking a picture in a continuous mode (several pictures shooting at once). Whenever a user manipulates the digital camera 100 in any manner, it is determined whether the user is manipulating the digital camera 100 in a manner in which the predetermined manipulation manner is defined. If so, an instruction corresponding to the predetermined manipulation manner for operating the digital camera 100 is assumed. For example, if a user rotates the digital camera 100 in an angle back and forth, then it may be determined that the user is making an instruction for regular mode picture taking, and if the user shifts the digital camera 100 within a distance back and forth, then it may be determined that the user is making an instruction for continuous mode picture taking.

As stated above, it is determined whether a user is intended to make an instruction when the user manipulates the digital camera 100 in any manner. The determination between intended movement by a user and not intended movement is attained by the generated electronic motion pattern of image frames on the digital camera 100 displayer (not shown). Specifically, when a user rotates the digital camera 100 back and forth in an angle, the image frames on the displayer of the digital camera 100 present a rotated electronic motion pattern, and when the user shifts the digital camera 100 leftwards or rightwards, the image frames on the displayer of the digital camera 100 present a leftward or rightward electronic motion pattern. The electronic motion pattern of image frames caused by user manipulation is compared with a predetermined motion pattern presented by a predetermined manipulation manner to determine a user's intention. Here, the predetermined motion pattern refers to an electronic motion pattern that is presented by a predetermined manipulation manner. For example, a predetermined manipulation manner of rotating the digital camera 100 presents a rotated electronic motion pattern on image frames, and a predetermined manipulation manner of shifting the digital camera 100 leftwards or rightwards presents a leftward or rightward electronic motion pattern on image frames. If the user generated electronic motion pattern (rotated electronic motion pattern, for example) matches an electronic motion pattern presented by a predetermined manipulation manner (rotating the digital camera 100 in an angle back and forth, for example), then it may be determined that the user is making an instruction corresponding to the predetermined manipulation manner (regular mode picture taking, for example) for operating the digital camera 100.

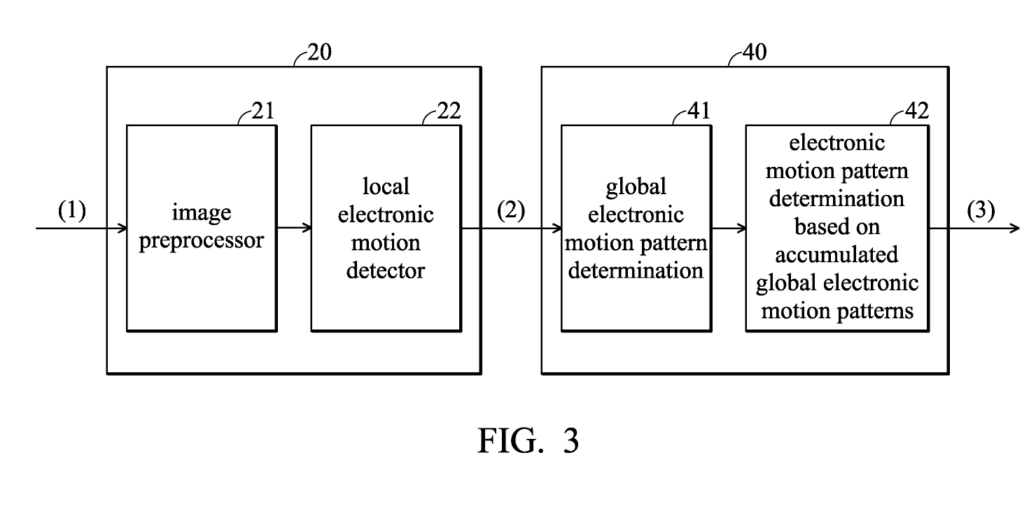

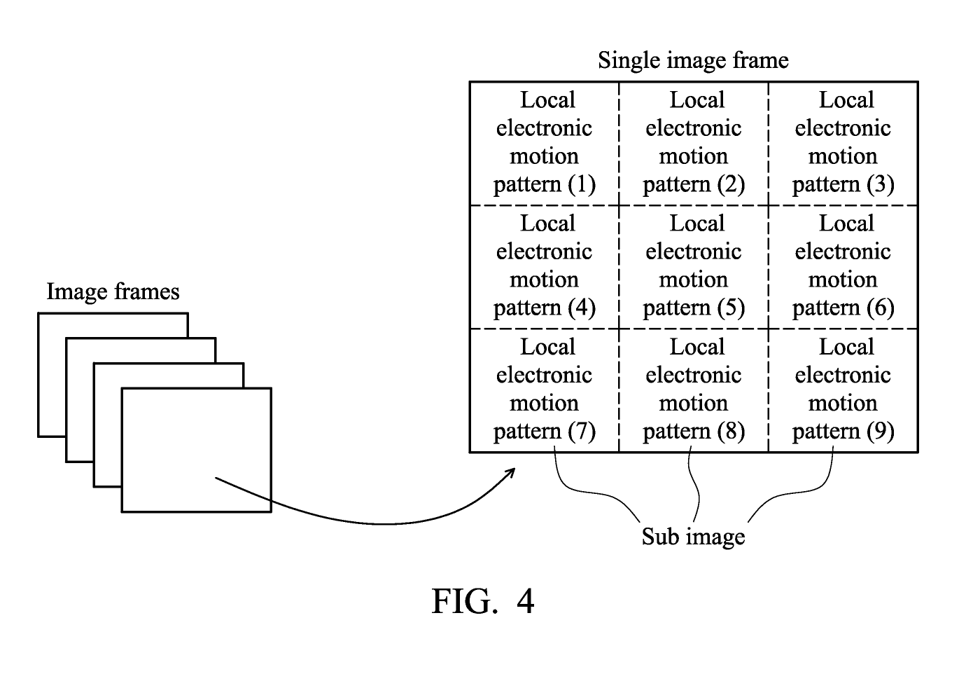

During user manipulation of the digital camera 100, the image sensor 10 captures sufficient image frames (continuous) for determining a presented electronic motion pattern of the image frames in order to determine whether the presented electronic motion pattern matches any predetermined motion pattern, thereby determining whether the user is making any instruction. The captured image frames are sent to the image processor 20 which comprises an image preprocessor 21 and a local motion detector 22, as shown in FIG. 3. The image preprocessor 21 filters the unwanted information contained in the image frames which may disturb the electronic motion pattern determination of the image frames, such as the noise component, as well as the Direct Current (DC) component which represents the illumination information of the image frames. Following the filtering step, the filtered image frames are sent to the local motion detector 22 to detect the local electronic motion pattern of the image frames. Each image frame is divided into a plurality of sub images, each sub image has its own electronic motion pattern (local electronic motion pattern as described above), as shown in FIG. 4. The local electronic motion patterns of all sub images of an image frame are determined by the local motion detector 22 and sent to the CPU 40 which determines a global electronic motion pattern of the image frame based on a predetermined mechanism (with all local electronic motion patterns taken into consideration and calculated together), as the procedure 41 performed by the CPU 40 shows in FIG. 3. In addition to determining a global electronic motion pattern for a single image frame, the CPU 40 further determines the global electronic motion patterns for all image frames captured during user manipulation and determines the user presented electronic motion pattern of the image frames according to the determined global electronic motion patterns, as the procedure 42 performed by the CPU 40 shows in FIG. 3.

As stated above, the electronic motion pattern generated during user manipulation is compared with a predetermined motion pattern presented by a predetermined manipulation manner to determine whether the user is making an instruction corresponding to the predetermined manipulation manner for operating the digital camera 100. If so, the CPU 40 may instruct the image sensor 10 to perform the requisite pre-procedures for taking picture, such as auto-focus. Meanwhile, the CPU 40 may control other related units (e.g. graphic unit 50) to render a message on the displayer of the digital camera 100 to notify the user that an instruction from the user for operating the digital camera 100 has been confirmed and the corresponding functional operation is going to be performed. Note that following the electronic motion pattern comparison (user presented electronic motion pattern versus predetermined motion pattern), an additional step may be further performed to re-confirm user intentions, such as whether or not the electronic motion pattern is for an instruction or not (e.g. a stationary position of the digital camera 100 or stationary electronic motion pattern). However, the additional step is not limited to checking for a stationary electronic motion pattern. With the additional step, the user is required to immediately fix the digital camera 100 so that it does not move following the manipulation of the digital camera 100 (rotating/shifting etc), to trigger a functional operation of the digital camera 100. Once the functional operation is performed to retrieve object images, the image data retrieved by the image sensor 10 is sent to the image processor 20 to be saved in the memory unit 30.

Note that if the functional operation is an instruction for continuous mode picture taking, then the continuous picture taking may be stopped by the identical user manipulation procedure that triggered the functional operation, or by pressing a button of the digital camera 100 if available. In addition, the speed of user manipulation for operating the digital camera 100 may be required to meet a condition to trigger a functional operation of the digital camera 100. In other words, the user may be required to rotate/shift the digital camera 100 in a speed fast enough to trigger the functional operation. In addition, the number of the accumulated image frames during user manipulation should be properly designated. Specifically, if the number of the accumulated image frames is too little, then the determined motion pattern of the image frames may not be accurate enough. In addition, the functional operation of the digital camera 100 is not limited to regular/continuous mode picture taking. The functional operation may be any function capable of being performed by the digital camera 100. In addition, different functional operations of the digital camera 100 may be defined by the same predetermined manipulation manner, but with different degrees to which the digital camera is operated. For example, a predetermined manipulation manner of rotating the digital camera 100 in an angle larger than 15 degrees may be regarded as an instruction for regular mode picture taking, and the same predetermined manipulation manner of rotating the digital camera 100 in another angle larger than 30 degrees may be regarded as another instruction for macro mode picture taking.

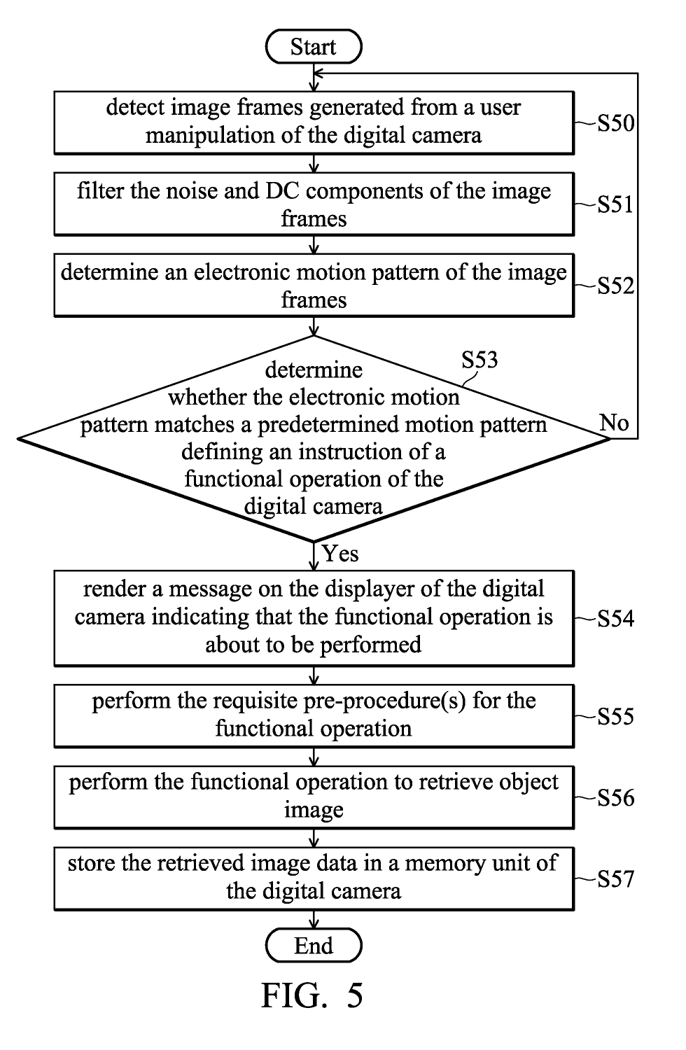

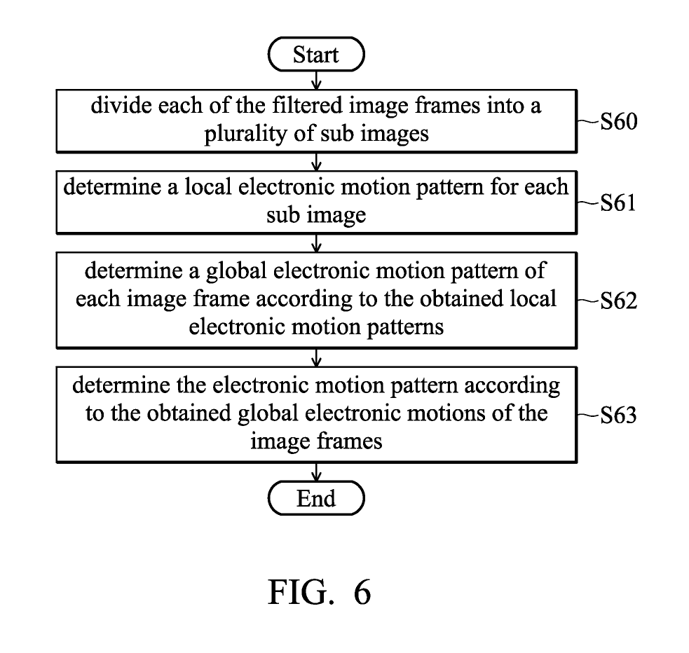

FIG. 5 shows an operation flowchart of a digital camera according to an embodiment of the invention. First, image frames generated from user manipulation of the digital camera are detected (step S50). Next, the noise and DC components of the image frames are filtered (step S51). Next, an electronic motion pattern of the image frames is determined according to the filtered image frames (step S52). Next, it is determined whether the electronic motion pattern is identical to a predetermined motion pattern defining an instruction of a functional operation of the digital camera (step S53). If so, a message indicating that the functional operation is about to be performed is rendered on the displayer of the digital camera (step S54) and the requisite pre-procedure(s) for the functional operation is performed (step S55). Next, the functional operation is performed to retrieve an object image (step S56). Finally, the retrieved image data is stored in a memory unit of the digital camera (step S57). FIG. 6 shows a detailed flowchart of the step S52 for determining the electronic motion pattern of image frames generated by user manipulation. First, each of the filtered image frames is divided into a plurality of sub images (step S60). Next, a local electronic motion pattern for each sub image is determined (step S61). Next, a global electronic motion pattern of each image frame is determined according to the obtained local electronic motion patterns (step S62). Finally, the electronic motion pattern is determined according to the obtained global motions of the image frames (step S63).

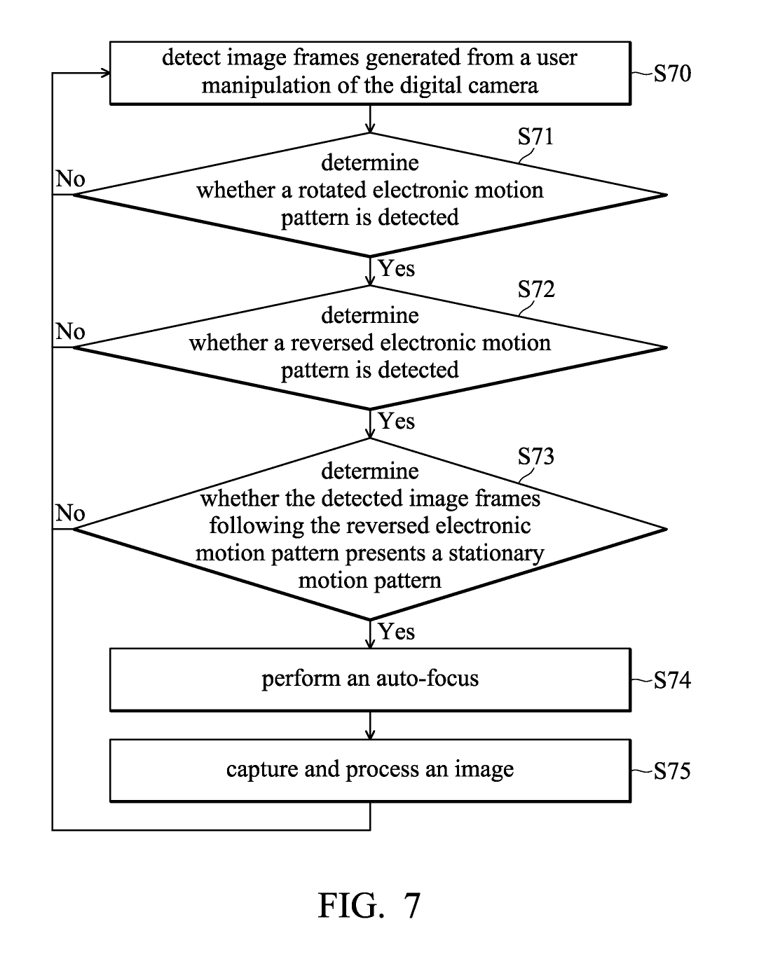

FIG. 7 shows a flowchart illustrating a practical application of the digital camera 100 according to an embodiment of the invention. First, the digital camera 100 is in a preview mode detecting image frames generated from a user manipulation of the digital camera 100 (S70). Next, it is determined whether a rotated electronic motion pattern is detected (S71). If not, the procedure goes back to step S70, continue to detect image frames. If so, it is determined whether a reversed electronic motion pattern with respect to the rotated electronic motion pattern in step S51 is detected (S72). If not, the procedure goes back to step S70, continue to detect image frames. If so, it is determined whether the detected image frames following the reversed electronic motion pattern in step S72 presents a stationary motion pattern (i.e. the user intentionally fixes the digital camera 100) (step S73). If not, it indicates that the user is not intentionally making any instruction for operating the digital camera 100, so the procedure goes back to step S70, continue to detect image frames. If so, it indicates that the user is making instruction for taking picture. Therefore, the auto-focus (a pre-procedure for taking picture) is performed (S74). Following the step S74, an image is captured and processed (step S75). In some embodiments, the steps S71, S72, and S73 are governed by a timer, in other words, in order to trigger the auto-focus step S74, each of the steps S71, S72, and S73 has to be fulfilled within a predetermined time period.

The proposed electronic motion pattern detection requires a user manipulation of a digital camera, i.e. requiring a user intentionally moving the digital camera for picture taking. In reality, the requirement of a user moving the digital camera for taking pictures may produce better picture quality (less blurred images) compared to the known method in which a user steadily holds the digital camera and then presses the shutter button for taking picture. This is because that the human hands may stay a lot steadier following a large hand movement. In addition, when a quick picture taking is required, the invention provides a way for a user to trigger the picture taking function by simply making a hand movement without operating the small shutter button. In addition, in the invention, the required time for triggering a picture taking function is typically shorter than a conventional delay shutter, which provides a better timing control. The invention also makes a better use for a light digital camera as the invention overcomes the vibration problem caused by small and light devices. The shutter-free method of the invention is more suitable in some occasions than the voice control method, and it eliminates the concerns regarding yield rate and cost as no additional components, calibration, or power consumption are required.

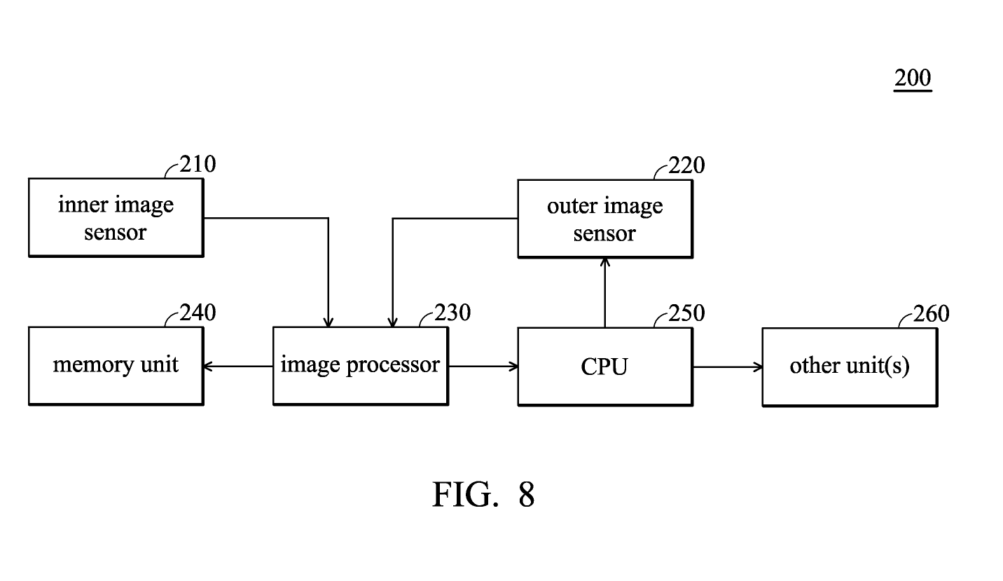

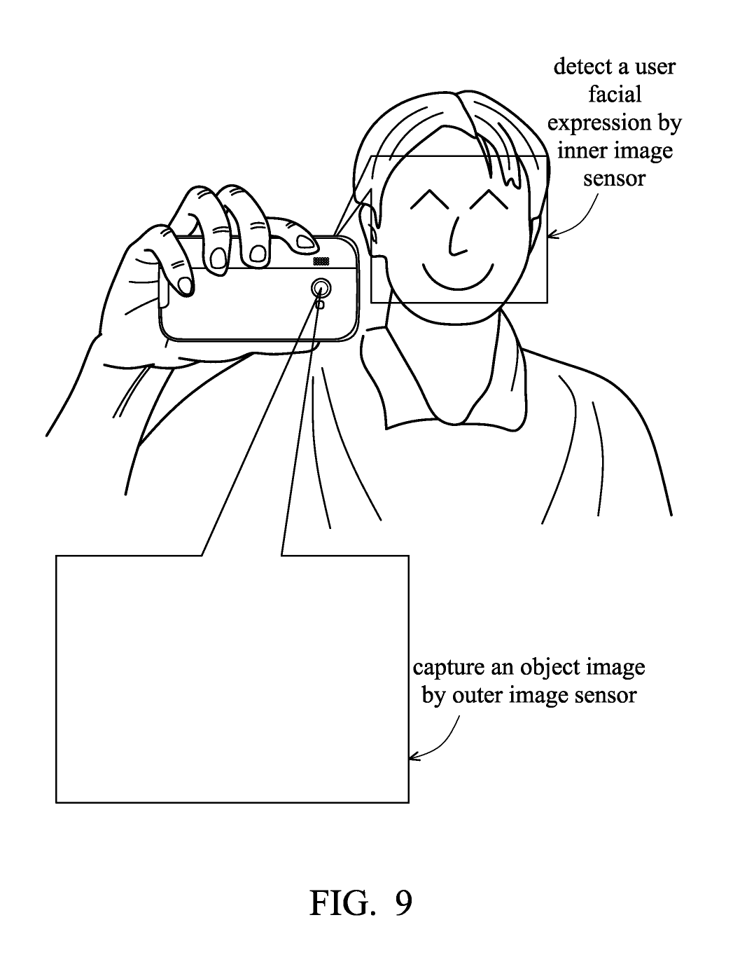

FIG. 8 shows a diagram of an electronic device according to another embodiment of the invention. The electronic device 200 comprises an inner image sensor 210, an outer image sensor 220, an image processor 230, a memory unit 240 a CPU 250 and other unit(s) 260 to be controlled by the CPU 250. The electronic device 200 may be a device capable of taking pictures, such as a digital camera, a PDA, a cell phone and the like. The inner image sensor 210 is an inner lens used to capture the image on the user's side. The outer image sensor 220 is an outer lens. The image sensor 10 is used to capture the object images, such as landscapes. While the traditional cameras require users to press a button for picture taking, the embodiment of the invention simply requires users to perform a predetermined facial expression (without pressing any button) in front of the digital camera 200 to trigger a functional operation of the digital camera 200, as shown in FIG. 9. The predetermined facial expression, for example, may be a smile, a wink of an eye, or a nod, but is not limited thereto. The predetermined facial expression serves as an instruction for a certain functional operation of the digital camera 200, and different predetermined facial expressions represent different instructions for different functional operations of the digital camera 200. For example, a predetermined smile facial expression may represent an instruction for taking a picture in a regular mode, and another predetermined facial expression of a wink of an eye may represent another instruction for taking a picture in a continuous mode. Whenever a user performs a facial expression, it is determined whether the user is performing the facial expression in a way in which the predetermined facial expression is defined. If so, the user is determined to be making an instruction corresponding to the predetermined facial expression for operating the digital camera 200. For example, if a user performs a smile facial expression, then it may be determined that the user is making an instruction for regular mode picture taking, and if the user performs a wink of an eye facial expression, then it may be determined that the user is making an instruction for continuous mode picture taking.

Whenever a user performs a facial expression in front of the digital camera 200, the inner image sensor 210 captures the image frames of the user facial expression. The captured image frames are sent to the image processor 230 for detecting the user facial expression presented by the captured image frames. The detected user facial expression is sent to the CPU 250 which compares the user facial expression with a predetermined facial expression to determine whether the user is making any instruction for operating the digital camera 200. If the comparison is consistent, the CPU 250 may instruct the outer image sensor 220 to perform the requisite pre-procedure(s) for taking picture, such as auto-focus. Meanwhile, the CPU 250 may control other related units (e.g. graphic unit 260) to render a message on the displayer of the digital camera 200 to notify the user that an instruction from user for operating the digital camera 200 has been confirmed and the corresponding functional operation is going to be performed. Note that following the facial expression comparison, an additional step may be further performed to re-confirm user intentions, such as determining the time period, such as one second, of the user's facial expression. Once the functional operation is performed to retrieve object images, the image data retrieved by the outer image sensor 220 is sent to the image processor 230 to be saved in the memory unit 240.

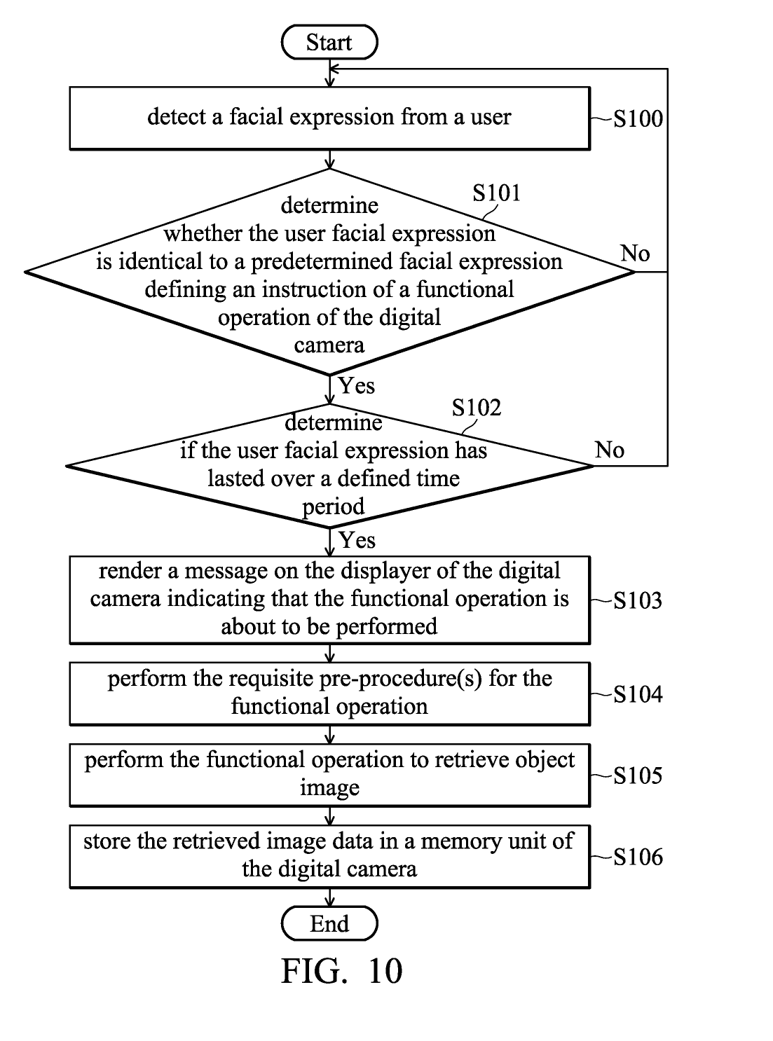

FIG. 10 shows an operation flowchart of a digital camera according to another embodiment of the invention. First, a facial expression from a user is detected (step S100). Next, it is determined whether the user facial expression is identical to a predetermined facial expression defining an instruction of a functional operation of the digital camera (step S101). If so, it is determined if the user facial expression has lasted over a defined time period (step S102). If not, it may not be an instruction for operating the digital camera. If so, a message indicating that the functional operation is about to be performed is rendered on the displayer of the digital camera (step S103) and the requisite pre-procedure(s) for the functional operation is performed (step S104). Next, the functional operation is performed to retrieve image frames (step S105). Finally, the retrieved image frames are stored in a memory unit of the digital camera (step S106).

Note that if the functional operation is an instruction for continuous mode picture taking, then the continuous picture taking may be stopped by the identical user facial expression that triggered the functional operation, or by pressing a button of the digital camera 200. In addition, the time period of a user facial expression may be required to meet a condition to trigger different functional operation of the digital camera 200. Specially, the user may be required to close his left eye longer than one second, for example, to trigger a functional operation of taking a picture in a regular mode. On the other hand, the user may be required to close his left eye longer than two seconds, for example, to trigger another functional operation of taking a picture in a macro mode. In addition, the functional operation of the digital camera 200 is not limited to regular/continuous/macro mode picture taking, it may be any function capable of being performed by the digital camera 200. In addition, the embodiment may apply to any electronic devices having both inner and outer lenses for taking pictures.

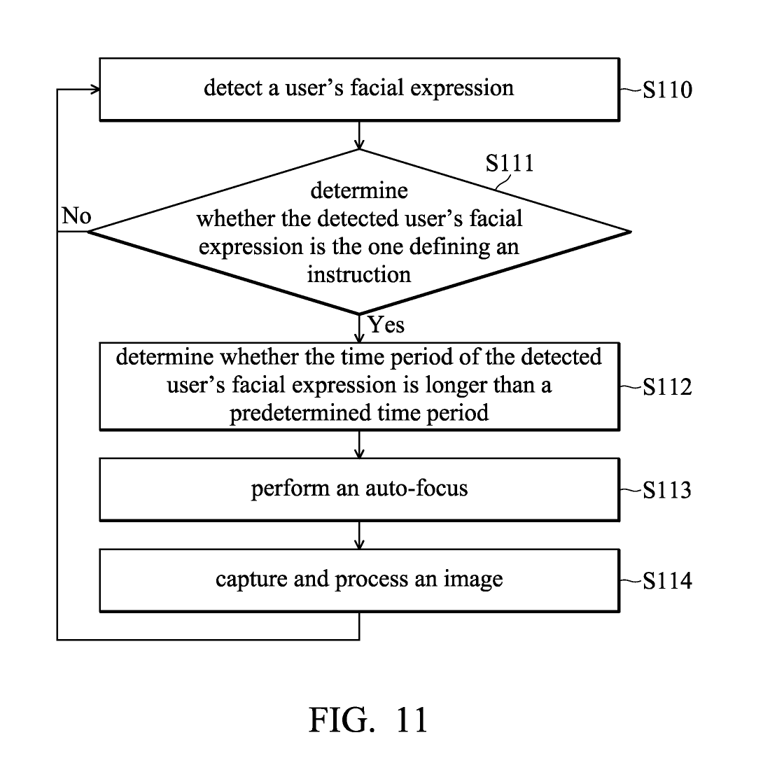

FIG. 11 shows a flowchart illustrating a practical application of the digital camera 200 according to an embodiment of the invention. First, the digital camera 200 is in a facial expression detection mode detecting a user's facial expression (S110). Next, it is determined whether the detected user's facial expression is the one defining an instruction for operating the digital camera 200, such as for taking a picture (S111). If not, the procedure goes back to step S110, continue to detect user's facial expression. If so, it is determined whether the time period of the detected user's facial expression is longer than a predetermined time period (S112). If not, it indicates that the user is not intentionally making any instruction for operating the digital camera 200, so the procedure goes back to step S110, continue to detect user's facial expression. If so, it indicates that the user is making instruction for taking picture, for example. Therefore, an auto-focus (a pre-procedure for taking picture) is performed (S113). Following the step S113, an image is captured and processed (step S114).

In the above embodiment, the proposed facial expression control doesn't require an external force (caused by a user manipulation) for operating a digital camera. Therefore, the digital camera may stay in a fixed position when operating, and would thus be less likely to capture a blurred image. In addition, the embodiment also allows a user to operate the digital camera without operating a small shutter button, which is more user friendly. By using an inner lens (inner image sensor) for detecting a user's facial expression, the required time for the inner lens to collect the image frames of a user's facial expression is shorter, which also provides a better timing control for taking a picture. In addition, for an electronic device already equipped with an inner lens, no more additional component is required. In addition, the invention provides a better utilization of both inner and outer lenses equipped on an electronic device, with the inner lens responsible for detecting a user's facial expression and the outer lens responsible for capturing object images.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
an image sensor detecting a plurality of image frames generated during the manipulation of the electronic device caused by external force; and
a central processing unit (CPU) determining an electronic motion pattern of the plurality of image frames, determining whether the electronic motion pattern matches a predetermined motion pattern defining a functional operation of the electronic device, and performing the functional operation when the electronic motion pattern matches the predetermined motion pattern.

2. The electronic device as claimed in claim 1, wherein the electronic device is a digital camera.

3. The electronic device as claimed in claim 1, further comprising a graphic unit, wherein the CPU further controls the graphic unit to render messages indicating that the functional operation is about to be performed, when the electronic motion pattern matches the predetermined motion pattern.

4. The electronic device as claimed in claim 1, wherein the CPU further determines a global electronic motion pattern for each of the plurality of image frames, and determines the electronic motion pattern according to the global electronic motion patterns of the plurality of image frames.

5. The electronic device as claimed in claim 4, further comprising an image processor comprising a local motion detector, wherein each of the plurality of image frames is divided into a plurality of sub images, and the local motion detector determines a local electronic motion pattern for each of the plurality of sub images for the CPU to determine the global electronic motion pattern.

6. The electronic device as claimed in claim 4, wherein the image processor further comprises an image preprocessor filtering the noise and direct current (DC) components of the plurality of image frames before the local motion detector.

7. The electronic device as claimed in claim 1, further comprising a memory unit, wherein the functional operation is a function capable of retrieving image data, and the retrieved image data is stored in the memory unit when the functional operation is performed.

8. The electronic device as claimed in claim 1, wherein the manipulation of the electronic device is a physical rotating or shifting of the electronic device.

9. The electronic device as claimed in claim 1, wherein the CPU further determines whether a subsequent electronic motion pattern of the plurality of image frames presents a stationary state when the electronic motion pattern matches the predetermined motion pattern.

10. A method for operating an electronic device, comprising the steps of:
detecting a plurality of image frames generated during the manipulation of the electronic device caused by external force;
determining an electronic motion pattern of the plurality of image frames;
determining whether the electronic motion pattern matches a predetermined motion pattern defining a functional operation of the electronic device; and
performing the functional operation when the electronic motion pattern matches the predetermined motion pattern.

11. The method as claimed in claim 10, wherein the electronic device is a digital camera.

12. The method as claimed in claim 10, further comprising rendering a message indicating that the functional operation is about to be performed when the electronic motion pattern matches the predetermined motion pattern.

13. The method as claimed in claim 10, further comprising the steps of:
determining a global electronic motion pattern for each of the plurality of image frames; and
determining the electronic motion pattern according to the global electronic motion patterns of the plurality of image frames.

14. The method as claimed in claim 13, further comprising the steps of:
dividing each of the plurality of image frames into a plurality of sub images; and
determining a local electronic motion pattern for each of the plurality of sub images for determining the global electronic motion pattern.

15. The method as claimed in claim 13, further comprising a step of filtering the noise and direct current (DC) components of the plurality of image frames before the dividing step.

16. The method as claimed in claim 10, wherein the functional operation is a function capable of retrieving image data, and the method further comprises a step of storing the retrieved image data in a memory unit of the electronic device when the functional operation is performed.

17. The method as claimed in claim 10, wherein the manipulation of the electronic device is a physical rotating or shifting of the electronic device.

18. The method as claimed in claim 10, further comprising a step of determining whether a subsequent electronic motion pattern of the plurality of image frames presents a stationary state when the electronic motion pattern matches the predetermined motion pattern.
